(19) United States
(12) Patent Application Publication
(10) Pub. No.: US 2018/0159798 A1
(43) Pub. Date: Jun. 7, 2018

(54) PACKET RELAY APPARATUS AND PACKET RELAY METHOD

(71) Applicant: SUMITOMO ELECTRIC INDUSTRIES, LTD., Osaka-shi, Osaka (JP)

(72) Inventors: Sumie TOMIYAMA, Osaka-shi, Osaka (JP); Satoru HATTORI, Osaka-shi, Osaka (JP)

(73) Assignee: SUMITOMO ELECTRIC INDUSTRIES, LTD., Osaka-shi, Osaka (JP)

(21) Appl. No.: 15/568,526

(22) PCT Filed: Jan. 4, 2016
(86) PCT No.: PCT/JP2016/050037

§ 371 Date: Oct. 23, 2017

(30) Foreign Application Priority Data
May 27, 2015 (JP) 2015-106927

(51) Int. Cl. H04L 12/947; H04L 12/741; H04L 29/06; H04L 12/717; H04L 12/721

(52) U.S. Cl. CPC H04L 49/252; H04L 45/74; H04L 45/566; H04L 45/42; H04L 69/22

(57) ABSTRACT

There are provided a packet relay apparatus and a packet relay method capable of reducing the load of processing a packet in an apparatus to which the packet is to be relayed. The packet relay apparatus includes: a reception unit configured to receive a packet; a management unit configured to add transfer information to the packet received by the reception unit and output the packet, the transfer information indicating that the packet is a packet transferred by the packet relay apparatus; and a relay unit configured to transmit the packet to an apparatus to which the packet is to be relayed, without adding the transfer information, when the packet received from the management unit has the transfer information.

### TECHNICAL FIELD

The present invention relates to a packet relay apparatus and a packet relay method, and particularly to a packet relay apparatus and a packet relay method that relay a packet.

### BACKGROUND ART

For example, “Request for Comments: 3315”, [online], July, 2003, Internet Engineering Task Force (IETF), [searched on Apr. 10, 2015], Internet <URL: https://www.ietf.org/rfc/rfc3315.txt> (NPD 1) defines an IPv6 Dynamic Host Configuration Protocol (DHCP) that enables a DHCPv6 server to pass an IPv6 address to an IPv6 node, i.e., a client.

For example, “Request for Comments: 6221”, [online], May, 2011, Internet Engineering Task Force (IETF), [searched on Apr. 10, 2015], Internet <URL: https://www.ietf org/rfc/rfc6221.txt> (NPD 2) defines an LDRA (Lightweight DHCPv6 Relay Agent) that is an apparatus not having the relay function.

### CITATION LIST

### Non Patent Document

NPD 1: “Request for Comments: 3315”, [online], July, 2003, Internet Engineering Task Force (IETF), [searched on Apr. 10, 2015], Internet <URL: https://www.ietforg/rfc/rfc3315.txt>
NPD 2: “Request for Comments: 6221”, [online], May, 2011, Internet Engineering Task Force (IETF), [searched on Apr. 10, 2015], Internet <URL: https://www.ietf org/rfc/rfc6221.txt>

### SUMMARY OF INVENTION

### Technical Problem

When a packet relay apparatus transfers a packet received from a client, the packet relay apparatus, for example, adds transfer information indicating that the packet relay apparatus has transferred the packet to the packet in accordance with RFC6221 (NPD 2).

When the packet relay apparatus relays the packet having the above-described transfer information added thereto to a different network, the packet relay apparatus, for example, adds transfer information indicating that the packet relay apparatus has transferred the packet to the packet in accordance with RFC3315 (NPD 1). The packet relay apparatus transmits the packet to a DHCPv6 server via the network.

The two types of transfer information are added to the packet received by the DHCPv6 server from the packet relay apparatus. Therefore, the following problem may arise.

When the two types of transfer information are added to the packet, the structure of the packet becomes complicated, for example. Therefore, the processing for analyzing the packet in the DHCPv6 server becomes complicated.

The present invention has been made to solve the above-described problem, and an object of the present invention is to provide a packet relay apparatus and a packet relay method capable of reducing the load of processing a packet in an apparatus to which the packet is to be relayed.

### Solution to Problem

(1) In order to solve the above-described problem, a packet relay apparatus according to an aspect of the present invention is a packet relay apparatus including: a reception unit configured to receive a packet; a management unit configured to add transfer information to the packet received by the reception unit and output the packet, the transfer information indicating that the packet is a packet transferred by the packet relay apparatus; and a relay unit configured to transmit the packet to an apparatus to which the packet is to be relayed, without adding the transfer information, when the packet received from the management unit has the transfer information.

(9) In order to solve the above-described problem, a packet relay method according to an aspect of the present invention is a packet relay method in a packet relay apparatus, the packet relay method including: receiving a packet; adding transfer information to the received packet and outputting the received packet in accordance with a first protocol, the transfer information indicating that the received packet is a packet transferred by the packet relay apparatus; and transmitting the packet to an apparatus to which the packet is to be relayed, in accordance with a second protocol, without adding the transfer information, when the received packet has the transfer information.

The present invention can be implemented not only as the packet relay apparatus including such characteristic processing units, but also as a semiconductor integrated circuit that implements a part or all of the packet relay apparatus. The present invention can be implemented as a communication system including the packet relay apparatus. The present invention can be implemented as a program for causing a computer to execute such characteristic processing steps.

### Advantageous Effects of Invention

According to the present invention, it is possible to reduce the load of processing a packet in an apparatus to which the packet is to be relayed.

### BRIEF DESCRIPTION OF DRAWINGS

FIG. 1 is a diagram showing a configuration of a communication system according to an embodiment of the present invention.

FIG. 2 is a diagram showing one example of a packet used in the communication system according to the embodiment of the present invention.

FIG. 3 is a diagram showing a configuration of a message included in the packet received and transmitted between a server and a packet relay apparatus in the communication system according to the embodiment of the present invention.

FIG. 4 is a diagram showing one example of a DHCPv6 packet used in the communication system according to the embodiment of the present invention.

FIG. 5 is a diagram showing a configuration of the packet relay apparatus in the communication system according to the embodiment of the present invention.

FIG. 6 is a diagram showing a configuration of a management processing unit in the packet relay apparatus according to the embodiment of the present invention.

FIG. 7 is a diagram showing one example of the DHCPv6 packet encapsulated in the management processing unit according to the embodiment of the present invention.

FIG. 8 is a diagram showing a configuration of a relay processing unit in the packet relay apparatus according to the embodiment of the present invention.

FIG. 9 is a diagram showing one example of an RF packet obtained by adding options in a line concentration relay unit according to the embodiment of the present invention.

FIG. 10 is a diagram showing one example of the DHCPv6 packet encapsulated in the line concentration relay unit according to the embodiment of the present invention.

FIG. 11 is a diagram showing one example of an RR packet created in the server according to the embodiment of the present invention.

FIG. 12 is a diagram showing one example of the RR packet created in the server according to the embodiment of the present invention.

FIG. 13 is a diagram showing one example of an RR packet obtained by deleting the options in the line concentration relay unit according to the embodiment of the present invention.

FIG. 14 is a flowchart defining an operation procedure when the packet relay apparatus according to the embodiment of the present invention performs the processing for relaying the DHCPv6 packet in an uplink direction.

FIG. 15 is a flowchart defining an operation procedure when the packet relay apparatus according to the embodiment of the present invention performs the processing for relaying the DHCPv6 packet in a downlink direction.

FIG. 16 is a diagram showing a configuration of a packet relay apparatus in a comparative example.

FIG. 17 is a diagram showing one example of a DHCPv6 packet encapsulated in a management processing unit of the packet relay apparatus in the comparative example.

FIG. 18 is a diagram showing one example of an RF packet encapsulated in a relay processing unit of the packet relay apparatus in the comparative example.

### DESCRIPTION OF EMBODIMENTS

First, details of an embodiment of the present invention will be described one by one.

(1) A packet relay apparatus according to the embodiment of the present invention includes: a reception unit configured to receive a packet; a management unit configured to add transfer information to the packet received by the reception unit and output the packet, the transfer information indicating that the packet is a packet transferred by the packet relay apparatus; and a relay unit configured to transmit the packet to an apparatus to which the packet is to be relayed, without adding the transfer information, when the packet received from the management unit has the transfer information.

With the configuration in which the packet is transmitted to the apparatus to which the packet is to be relayed, without adding a plurality of types of transfer information to one packet, the packet having a simple structure can be transmitted to the apparatus to which the packet is to be relayed. The processing for analyzing the packet in the apparatus to which the packet is to be relayed can be simplified. Therefore, it is possible to reduce the load of processing the packet in the apparatus to which the packet is to be relayed.

(2) Preferably, the management unit is configured to further add management information to the packet and output the packet, the management information being the information about an apparatus having transmitted the packet and being the information used to determine the apparatus having transmitted the packet in the apparatus to which the packet is to be relayed.

With this configuration, the apparatus to which the packet is to be relayed can, for example, correctly obtain the management information or obtain the management information by the simple processing. Therefore, the apparatus having transmitted the packet can be appropriately determined using the management information.

(3) Preferably, the relay unit is configured to add output source information to the packet received from the management unit, and transmit the packet to the apparatus to which the packet is to be relayed, the output source information indicating the management unit having output the packet.

With this configuration, even if the packet relay apparatus includes a plurality of management units, for example, the relay unit can correctly determine the management unit to which a response packet to the packet transmitted to the apparatus to which the packet is to be relayed is to be output, based on the output source information included in the response packet, when the relay unit receives the response packet from the apparatus.

(4) More preferably, the reception unit is configured to further receive a response packet from the apparatus to which the packet is to be relayed, the response packet being a response packet to the packet transmitted by the packet relay apparatus and being a packet including the output source information, and the relay unit is configured to obtain the output source information from the response packet received by the reception unit, and output the response packet from which the output source information has been deleted to the management unit indicated by the output source information.

With this configuration in which the response packet from which the output source information has been deleted is output, the type of the packet corresponding to the type of the packet output by the management unit can be output to the management unit. Therefore, the processing in the management unit can be simplified.

(5) Preferably, the management unit is configured to be able to set whether or not to add the transfer information, and the relay unit is configured to add the transfer information to the packet and transmit the packet to the apparatus to which the packet is to be relayed, when the packet received from the management unit does not have the transfer information.

With this configuration, the management unit can select whether or not to add the transfer information to the packet. Even if the management unit does not add the transfer information to the packet, the relay unit adds the transfer information to the packet, and thus, the apparatus to which the packet is to be relayed can correctly process the packet received from the packet relay apparatus.

(6) More preferably, the management unit is configured to further add addition information to the packet, the addition information indicating that the management unit has added the transfer information to the packet received by the reception unit, and the relay unit is configured to add the transfer information to the packet and transmit the packet to the apparatus to which the packet is to be relayed, when the packet received from the management unit does not have the addition information.

With this configuration, the relay unit can correctly determine whether or not the management unit has added the transfer information, based on the addition information. Therefore, addition of a plurality of types of transfer information to one packet can be more reliably prevented by the simple processing.

(7) More preferably, the reception unit is configured to further receive a response packet from the apparatus to which the packet is to be relayed, the response packet being a response packet to the packet transmitted by the packet relay apparatus and being a packet including response information indicating a response to the transfer information, and the relay unit is configured to output the response packet from which the response information has been deleted to the management unit, when the response packet received by the reception unit does not have the addition information.

With this configuration in which the response packet from which the response information has been deleted is output to the management unit that has output the packet not having the transfer information added thereto to the relay unit, the type of the packet corresponding to the type of the packet output by the management unit can be output to the management unit. Therefore, the processing in the management unit can be simplified.

(8) Preferably, the management unit and the relay unit are configured to operate in accordance with RFC6221 and RFC3315, respectively.

With this configuration, the management unit and the relay unit satisfy the specifications of RFC6221 and RFC3315, respectively. Therefore, the packet received and transmitted between the apparatus to which the packet is to be relayed and the apparatus having transmitted the packet, which satisfy these specifications, can be appropriately relayed.

(9) A packet relay method according to the embodiment of the present invention is a packet relay method in a packet relay apparatus, the packet relay method including: receiving a packet; adding transfer information to the received packet and outputting the received packet in accordance with a first protocol, the transfer information indicating that the received packet is a packet transferred by the packet relay apparatus; and transmitting the packet to an apparatus to which the packet is to be relayed, in accordance with a second protocol, without adding the transfer information, when the received packet has the transfer information.

With this configuration in which the packet is transmitted to the apparatus to which the packet is to be relayed, without adding a plurality of types of transfer information to one packet, the packet having a simple structure can be transmitted to the apparatus to which the packet is to be relayed. Therefore, the processing for analyzing the packet in the apparatus to which the packet is to be relayed can be simplified. Therefore, it is possible to reduce the load of processing the packet in the apparatus to which the packet is to be relayed.

The embodiment of the present invention will be described hereinafter with reference to the drawings, in which the same or corresponding portions are denoted by the same reference characters and description thereof will not be repeated. At least a part of the embodiment described below may be arbitrarily combined.

[Configuration and Basic Operation]

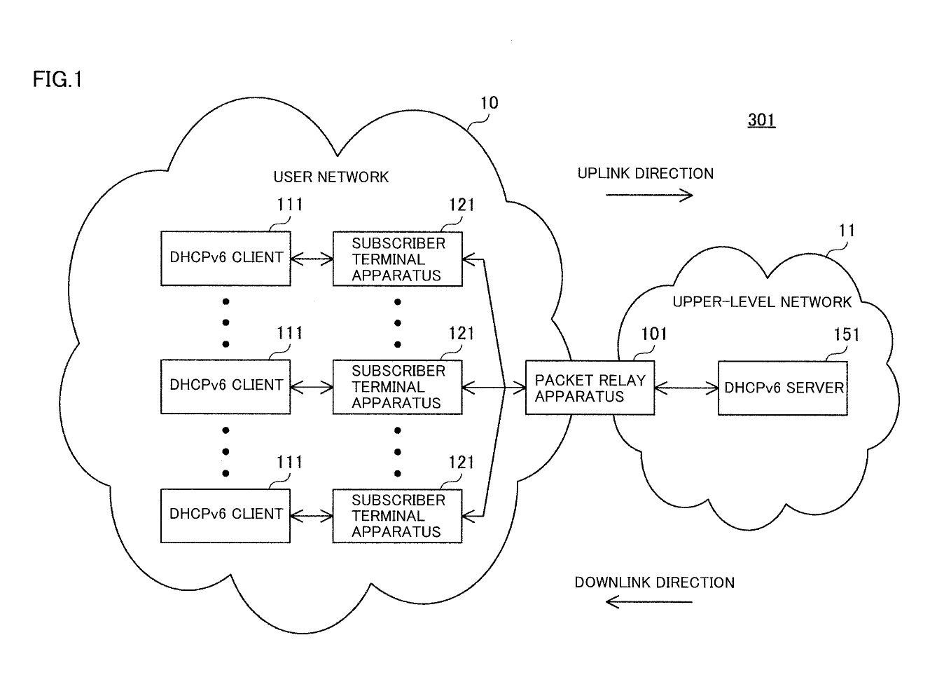

FIG. 1 is a diagram showing a configuration of a communication system according to the embodiment of the present invention.

Referring to FIG. 1, a communication system 301 includes a packet relay apparatus 101, a plurality of DHCPv6 clients (hereinafter also referred to as “clients”) 111, a plurality of subscriber terminal apparatuses 121, and a DHCPv6 server (hereinafter also referred to as “server”) 151.

Although the plurality of subscriber terminal apparatuses 121 are typically shown in FIG. 1, one subscriber terminal apparatus 121 may be provided. In addition, one client 111 is typically shown for one subscriber terminal apparatus 121. However, a plurality of clients 111 may be provided for one subscriber terminal apparatus 121.

The plurality of clients 111, the plurality of subscriber terminal apparatuses 121 and packet relay apparatus 101 form a user network 10, for example.

Packet relay apparatus 101 and server 151 form an upper-level network 11, for example. In FIG. 1, packet relay apparatus 101 is directly connected to server 151. However, packet relay apparatus 101 may be connected to server 151 with another relay apparatus interposed therebetween.

User network 10 and upper-level network 11 are different networks. More specifically, subnets of user network 10 and upper-level network 11 are different.

Client 111 in communication system 301 is, for example, a computer and is provided in a subscriber's home. Subscriber terminal apparatus 121 is, for example, an ONTJ (Optical Network Unit) and is provided in the subscriber's home.

In communication system 301, client 111 and packet relay apparatus 101, for example, mutually receive and transmit a packet, specifically an IPv6 packet, through subscriber terminal apparatus 121.

More specifically, subscriber terminal apparatus 121 and packet relay apparatus 101 are, for example, connected by an optical fiber. An optical signal is received and transmitted between subscriber terminal apparatus 121 and packet relay apparatus 101.

When subscriber terminal apparatus 121 transmits the optical signal including the packet to packet relay apparatus 101, subscriber terminal apparatus 121 transmits the optical signal including the packet together with a preamble including an ID of subscriber terminal apparatus 121 to packet relay apparatus 101.

Packet relay apparatus 101 and server 151, for example, mutually receive and transmit the packet, specifically the IPv6 packet.

Packet relay apparatus 101, for example, relays the packet received and transmitted between client 111 connected to user network 10 and server 151 connected to upper-level network 11.

Specifically, packet relay apparatus 101, for example, receives a DHCPv6 packet including a request for an IPv6 address and addressed to server 151 from client 111 via subscriber terminal apparatus 121. Packet relay apparatus 101 transmits the received DHCPv6 packet to server 151.

In addition, packet relay apparatus 101, for example, receives a DHCPv6 packet including a response to the request for the IPv6 address and addressed to client 111 from server 151. Packet relay apparatus 101 transmits the received DHCPv6 packet to client 111 via subscriber terminal apparatus 121.

Hereinafter, a direction from client 111 to server 151 will be referred to as “uplink direction”, and a direction from server 151 to client 111 will be referred to as “downlink direction”.

[Configuration of Packet]

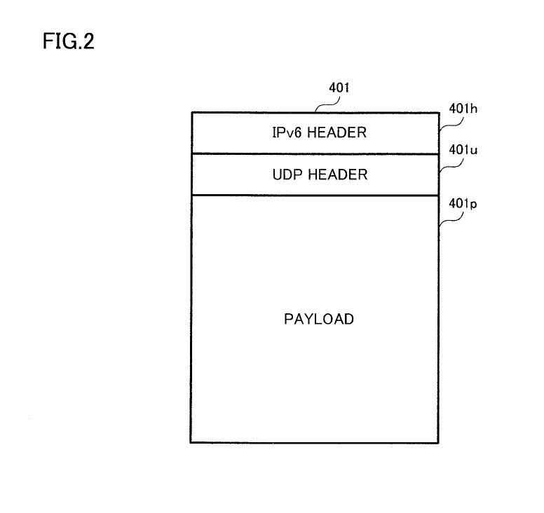

FIG. 2 is a diagram showing one example of a packet used in the communication system according to the embodiment of the present invention.

Referring to FIG. 2, a packet 401 includes an IPv6 header 401h, a UDP header 401u and a payload 401p.

[Configuration of Message]

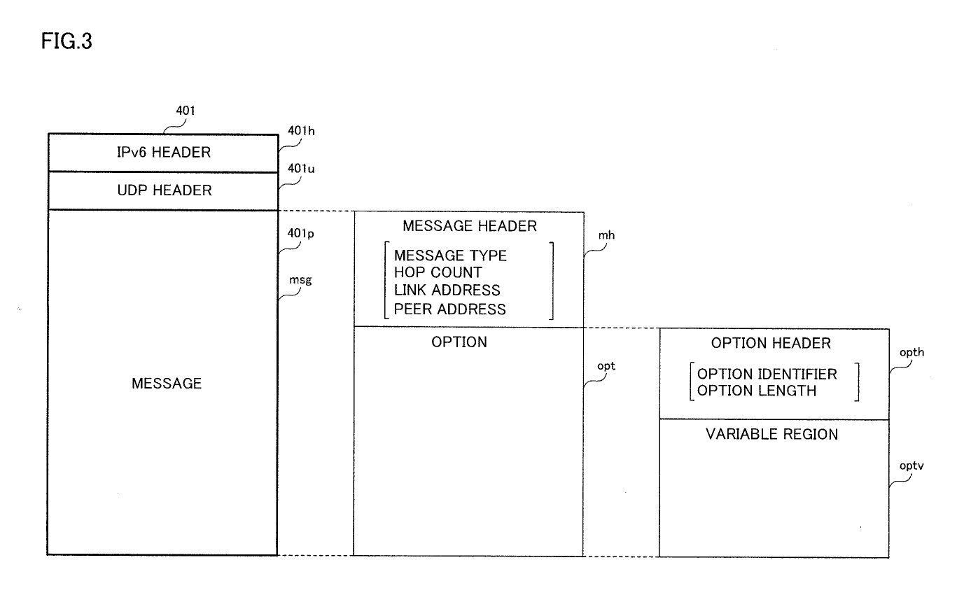

FIG. 3 is a diagram showing a configuration of a message included in the packet received and transmitted between the server and the packet relay apparatus in the communication system according to the embodiment of the present invention.

Referring to FIG. 3, a packet including a message msg in payload 401p of packet 401 is, for example, received and transmitted between server 151 and packet relay apparatus 101.

Message msg includes a message header mh and an option opt. Although one option opt is typically shown in FIG. 3, more options opt may be included in message msg.

Examples of message msg include a Relay-forward Message, a Relay-reply Message and the like.

Examples of option opt include a Relay Message Option, an Interface ID Option, a Vender Specific Option and the like.

Hereinafter, the Relay Message Option, the Interface ID Option and the Vender Specific Option will be also referred to as “RM option”, “IID option” and “VS option”, respectively.

A field length of message header mh is, for example, a fixed value. Message header mh includes, for example, a message type, a hop count, a link address, and a peer address.

A field length of option opt is, for example, a variable value. Option opt includes an option header opth and a variable region optv.

A field length of option header opth is, for example, a fixed value. Option header opth includes, for example, an option identifier indicating a type of option opt, and an option length.

A field length of variable region optv is, for example, a length indicated by the option length. Variable region optv includes information corresponding to the option identifier.

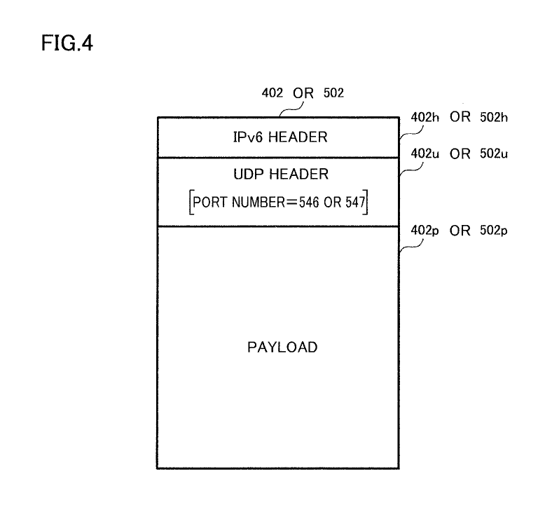

For example, even if the plurality of options opt are included in message msg, server 151 and packet relay apparatus 101 can obtain each option opt based on the option identifier and the option length included in option header opth.

[Configuration of DHCPv6 Packet] FIG. 4 is a diagram showing one example of a DHCPv6 packet used in the communication system according to the embodiment of the present invention.

Referring to FIGS. 1 and 4, client 111, for example, creates a DHCPv6 packet 402. As for DHCPv6 packet 402, request information for providing a request for an IPv6 address to server 151 is stored in a payload 402p. A prescribed port number indicating that DHCPv6 packet 402 is a packet used for DHCP processing is included in a UDP header 402u of DHCPv6 packet 402. This port number is, for example, 547.

Client 111, for example, transmits created DHCPv6 packet 402 to packet relay apparatus 101 via subscriber terminal apparatus 121.

[Configuration of Packet Relay Apparatus]

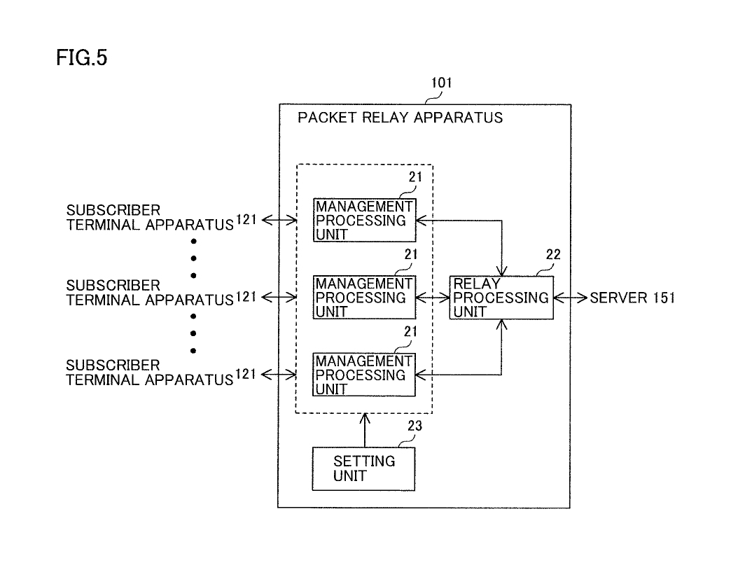

FIG. 5 is a diagram showing a configuration of the packet relay apparatus in the communication system according to the embodiment of the present invention.

Referring to FIG. 5, packet relay apparatus 101 includes three management processing units 21, a relay processing unit 22 and a setting unit 23.

Although three management processing units 21 are typically shown in FIG. 5, more or less management processing units 21 may be provided. Although one relay processing unit 22 is typically shown, more relay processing units 22 may be provided.

Setting unit 23, for example, accepts a user's operation. In accordance with the accepted user's operation, setting unit 23 sets operation modes of management processing unit 21 at either a management mode or a non-management mode. Setting unit 23 can, for example, set the different operation modes for three management processing units 21, or can set one single operation mode for three management processing units 21.

Management processing unit 21, for example, manages a subscriber under packet relay apparatus 101. Specifically, management processing unit 21, for example, manages subscriber terminal apparatus 121.

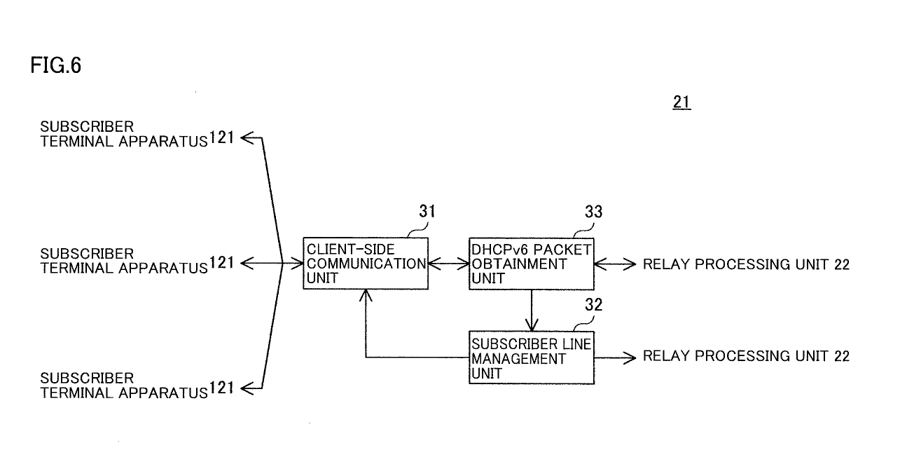

FIG. 6 is a diagram showing a configuration of the management processing unit in the packet relay apparatus according to the embodiment of the present invention.

Referring to FIG. 6, management processing unit 21 includes a client-side communication unit (reception unit) 31, a subscriber line management unit 32 and a DHCPv6 packet obtainment unit 33.

In FIG. 6, client-side communication unit 31 is, for example, connected to three subscriber terminal apparatuses 121. Client-side communication unit 31 may be connected to two or less or four or more subscriber terminal apparatuses 121.

Client-side communication unit 31 and three subscriber terminal apparatuses 121 form a PON (Passive Optical Network), for example.

In the PON, client-side communication unit 31 is, for example, connected to three subscriber terminal apparatuses 121 by an optical fiber, with an optical splitter interposed therebetween.

Instead of the PON, client-side communication unit 31 may be connected to a cable modem or the like by an electric signal line, with a branch circuit interposed therebetween.

Client-side communication unit 31 receives packet 401. More specifically, client-side communication unit 31, for example, receives the optical signal including the preamble and packet 401 from subscriber terminal apparatus 121. Client-side communication unit 31 converts the received optical signal into an electric signal and outputs the electric signal to DHCPv6 packet obtainment unit 33.

Client-side communication unit 31, for example, receives an electric signal including packet 401 from DHCPv6 packet obtainment unit 33 or subscriber line management unit 32. Client-side communication unit 31 converts the received electric signal into an optical signal and transmits the optical signal to subscriber terminal apparatus 121.

DHCPv6 packet obtainment unit 33, for example, monitors the electric signal received from client-side communication unit 31. When DHCPv6 packet obtainment unit 33 detects the preamble from the electric signal, DHCPv6 packet obtainment unit 33 obtains the preamble and packet 401 that follows the preamble.

When the port number included in UDP header 401u of obtained packet 401 is, for example, 547, DHCPv6 packet obtainment unit 33 recognizes that packet 401 is DHCPv6 packet 402. DHCPv6 packet obtainment unit 33 outputs DHCPv6 packet 402 and the preamble to subscriber line management unit 32.

When the above-described port number is, for example, the number other than 547, DHCPv6 packet obtainment unit 33 recognizes that packet 401 is a normal packet to be relayed. DHCPv6 packet obtainment unit 33 outputs packet 401 to relay processing unit 22.

Subscriber line management unit 32 can, for example, set whether or not to add transfer information to DHCPv6 packet 402. More specifically, when the operation mode of management processing unit 21 of subscriber line management unit 32 is, for example, in the management mode by setting unit 23, subscriber line management unit 32 adds the transfer information to DHCPv6 packet 402.

On the other hand, when the operation mode of management processing unit 21 of subscriber line management unit 32 is, for example, in the non-management mode by setting unit 23, subscriber line management unit 32 does not add the transfer information to DHCPv6 packet 402. The details of the transfer information will be described below.

Subscriber line management unit 32 is not limited to the configuration of being able to set whether or not to add the transfer information to DHCPv6 packet 402. Subscriber line management unit 32 may be configured to add the transfer information to DHCPv6 packet 402 by default.

More specifically, upon reception of DHCPv6 packet 402 and the preamble from DHCPv6 packet obtainment unit 33 when the operation mode of management processing unit 21 of subscriber line management unit 32 is, for example, in the non-management mode, subscriber line management unit 32 outputs received DHCPv6 packet 402 to relay processing unit 22 without any change.

On the other hand, upon reception of DHCPv6 packet 402 and the preamble from DHCPv6 packet obtainment unit 33 when the operation mode of management processing unit 21 of subscriber line management unit 32 is, for example, in the management mode, subscriber line management unit 32 starts the management processing for DHCPv6 packet 402 in accordance with a first protocol, specifically RFC6221.

Specifically, subscriber line management unit 32, for example, keeps a correspondence relation between an ID of subscriber terminal apparatus 121 and an ONU index. Subscriber line management unit 32, for example, obtains the ID of subscriber terminal apparatus 121 from the preamble received from DHCPv6 packet obtainment unit 33. Based on the correspondence relation, subscriber line management unit 32 identifies the ONU index corresponding to the obtained ID.

[Management Processing and Encapsulation]

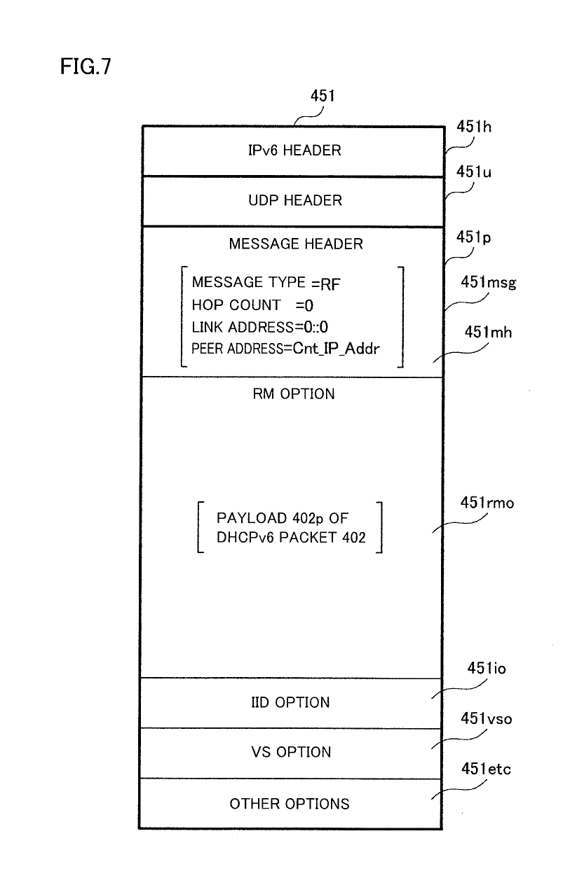

FIG. 7 is a diagram showing one example of the DHCPv6 packet encapsulated in the management processing unit according to the embodiment of the present invention.

Referring to FIG. 7, subscriber line management unit 32 adds the transfer information indicating that DHCPv6 packet 402 is a packet transferred by packet relay apparatus 101 of subscriber line management unit 32, to DHCPv6 packet 402 received by client-side communication unit 31.

Subscriber line management unit 32, for example, further adds management information to DHCPv6 packet 402. The management information is the information about an apparatus having transmitted DHCPv6 packet 402, and is used to determine the apparatus having transmitted DHCPv6 packet 402 in an apparatus to which DHCPv6 packet 402 is to be relayed.

Subscriber line management unit 32, for example, further adds addition information to DHCPv6 packet 402. The addition information is the information indicating that the transfer information has been added to DHCPv6 packet 402 received by client-side communication unit 31.

Specifically, subscriber line management unit 32, for example, creates a message 451msg including payload 402p of DHCPv6 packet 402, the transfer information, the management information, and the addition information, and creates a DHCPv6 relay forward packet (hereinafter also referred to as “RF packet”) 451. As for DHCPv6 relay forward packet 451, created message 451msg is stored in a payload 451p.

More specifically, subscriber line management unit 32, for example, creates an IPv6 header 451h and a UDP header 451u obtained by copying IPv6 header 402h and UDP header 402u of DHCPv6 packet 402, respectively.

At this time, subscriber line management unit 32, for example, obtains an IPv6 address of the transmission source, i.e., an IPv6 address of client 111, from IPv6 header 402h. Furthermore, subscriber line management unit 32 rewrites the address information included in IPv6 header 451h, when needed. The IPv6 address of client 111 is, for example, Cnt_IP_Addr.

Subscriber line management unit 32, for example, creates a message header 451mh having “RF”, “0”, “0::0”, and “Cnt_IP_Addr” written thereinto as the message type, the hop count, the link address, and the peer address, respectively.

This “RF” which is the message type included in message header 451mh corresponds to the above-described transfer information, for example. The message type “RF” means, for example, that message 451msg is a relay forward message. The hop count “0” means, for example, that RF packet 451 has hopped one time. The link address “0::0” means, for example, that subscriber line management unit 32 does not perform the relay processing. The peer address “Cnt_IP_Addr” is the IPv6 address of client 111 as described above.

In addition, subscriber line management unit 32, for example, creates an RM option 451rmo. As for RM option 451rmo, a copy of payload 402p of DHCPv6 packet 402 is stored in variable region optv.

Incorporation of the content of payload 401p of certain packet 401 into the RM option of message msg as described above will be hereinafter referred to as encapsulation of packet 401.

In addition, subscriber line management unit 32, for example, creates an IID option 451io in which the above-described identified ONU index is stored in variable region optv as the management information.

Subscriber line management unit 32 is not limited to the configuration of creating IID option 451io including the ONU index as the management information, and may be configured to create IID option 451io including, as the management information, an MAC (Media Access Control) address of subscriber terminal apparatus 121 having transmitted DHCPv6 packet 402.

In addition, subscriber line management unit 32, for example, creates a VS option 451vso in which a prescribed identification code Cd is stored in variable region optv as the addition information.

In addition, subscriber line management unit 32, for example, creates other options 451etc when needed.

Subscriber line management unit 32, for example, creates RF packet 451 by combining IPv6 header 451h, UDP header 451u, message header 451mh, RM option 451rmo, IID option 451io, VS option 451vso, and other options 451etc in the listed order. The order of options opt in RF packet 451 may be changed.

Subscriber line management unit 32 outputs RF packet 451 thus created to relay processing unit 22.

[Relay Processing]

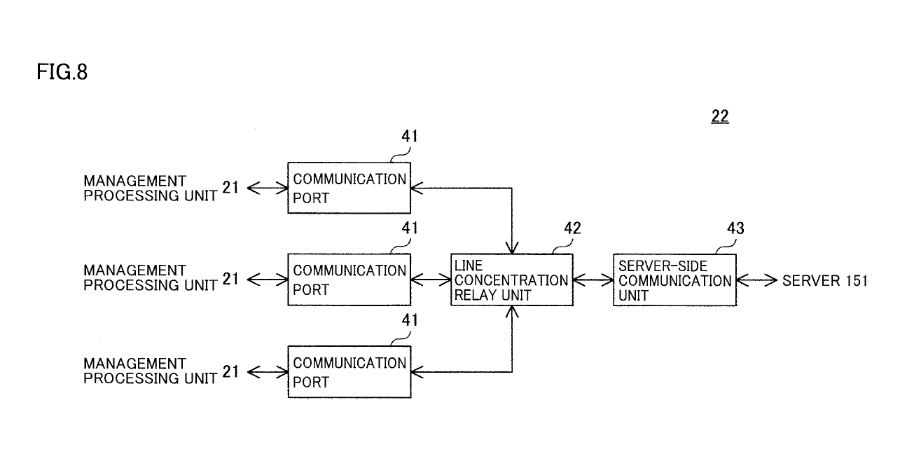

FIG. 8 is a diagram showing a configuration of the relay processing unit in the packet relay apparatus according to the embodiment of the present invention.

Referring to FIG. 8, relay processing unit 22 includes three communication ports 41, a line concentration relay unit 42 and a server-side communication unit (reception unit) 43.

Although three communication ports 41 are typically shown in FIG. 8, more or less communication ports 41 may be provided. Although one line concentration relay unit 42 is typically shown, more line concentration relay units 42 may be provided.

Line concentration relay unit 42 in relay processing unit 22, for example, performs the processing for relaying packet 401 between user network 10 and upper-level network 11 in accordance with a second protocol, specifically RFC3315.

For example, each communication port 41 is connected to each management processing unit 21 in packet relay apparatus 101 shown in FIG. 5 in one-to-one relation. A communication port number which is an identifier of each communication port 41 and an IPv6 address are assigned to each communication port 41.

When communication port 41 receives DHCPv6 packet 402 or RF packet 451 from management processing unit 21, communication port 41, for example, outputs received DHCPv6 packet 402 or RF packet 451 to line concentration relay unit 42.

Line concentration relay unit 42, for example, keeps the communication port number and the IPv6 address of each communication port 41.

When line concentration relay unit 42 receives DHCPv6 packet 402 or RF packet 451 from communication port 41, line concentration relay unit 42, for example, identifies the communication port number and the IPv6 address of communication port 41. The communication port number and the IPv6 address identified by line concentration relay unit 42 are, for example, Pnum and RP_JP_Addr, respectively.

[RF Packet 452 Including Addition Information]

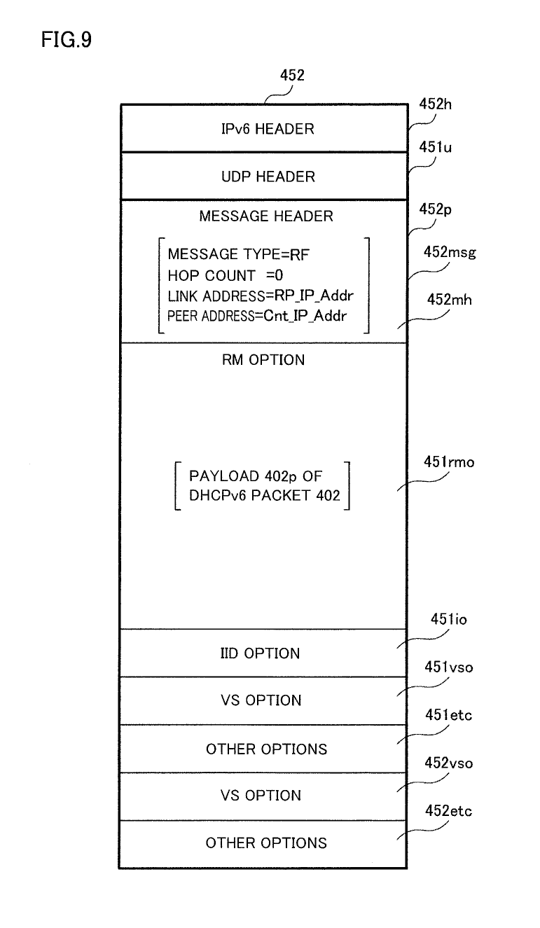

FIG. 9 is a diagram showing one example of an RF packet obtained by adding options in the line concentration relay unit according to the embodiment of the present invention.

Referring to FIG. 9, when the packet received from subscriber line management unit 32 has the transfer information, line concentration relay unit 42 transmits the packet to the apparatus to which the packet is to be relayed, specifically server 151, without adding the transfer information.

Specifically, line concentration relay unit 42, for example, performs check processing CT1 for checking whether or not RF packet 451 received from subscriber line management unit 32 includes the VS option including identification code Cd.

When line concentration relay unit 42 checks in check processing CT1 that RF packet 451 includes VS option 451vso including identification code Cd, line concentration relay unit 42, for example, recognizes that RF packet 451 is a packet to which the transfer information, i.e., “RF” indicating the message type in message header 451mh has been added in subscriber line management unit 32.

Line concentration relay unit 42, for example, creates an RF packet 452 based on RF packet 451. More specifically, line concentration relay unit 42, for example, rewrites the address information included in IPv6 header 451h in RF packet 451 when needed, and creates an IPv6 header 452h. In addition, line concentration relay unit 42, for example, creates a message 452msg based on message 451msg.

Line concentration relay unit 42, for example, adds output source information indicating subscriber line management unit 32 having output the packet, to the packet received from subscriber line management unit 32, and transmits the packet to server 151.

The output source information is, for example, Pnum which is the above-described identified communication port number, and RP_IP_Addr which is the IPv6 address. Pnum and RP_IP_Addr indicate communication port 41 that has received DHCPv6 packet 402 or RF packet 451. Since communication port 41 and management processing unit 21 are connected in one-to-one relation, Pnum and RP_IP_Addr substantially indicate management processing unit 21, i.e., subscriber line management unit 32. The output source information is not limited to the information such as the communication port number and the IPv6 address for identifying communication port 41. As long as the output source information is the information that can identify management processing unit 21, the output source information may be an IPv6 address, an MAC address or the like of management processing unit 21.

Line concentration relay unit 42, for example, creates a VS option 452vso including Pnum in variable region optv as the output source information. Line concentration relay unit 42 appends created VS option 452vso to other options 451etc.

Line concentration relay unit 42, for example, rewrites the link address, i.e., “0::0” in message header 451mh of RF packet 451 into “RP_IP_Addr” which is the above-described identified IPv6 address, and creates a message header 452mh. The link address “RP_IP_Addr” means, for example, that line concentration relay unit 42 has performed the relay processing.

In addition, line concentration relay unit 42, for example, creates other options 452etc when needed. Line concentration relay unit 42 appends created other options 452etc to VS option 452vso.

Line concentration relay unit 42 outputs RF packet 452 thus created to server-side communication unit 43.

[RF Packet 453 not Including Addition Information]

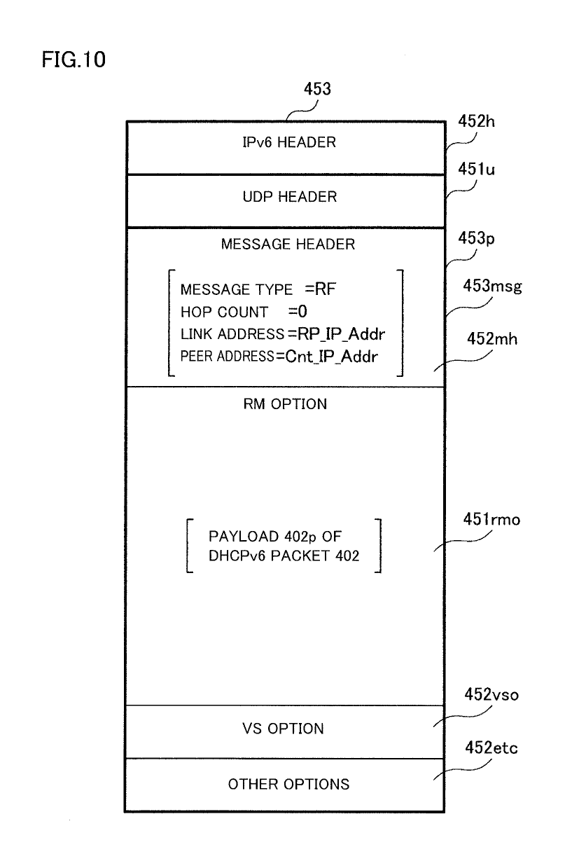

FIG. 10 is a diagram showing one example of the DHCPv6 packet encapsulated in the line concentration relay unit according to the embodiment of the present invention.

When the packet received from subscriber line management unit 32 does not have the transfer information, line concentration relay unit 42, for example, adds the transfer information to the packet and transmits the packet to server 151.

Specifically, when the packet received from subscriber line management unit 32 does not have the addition information, line concentration relay unit 42, for example, adds the transfer information to the packet and transmits the packet to server 151.

More specifically, line concentration relay unit 42, for example, receives DHCPv6 packet 402 from communication port 41 and performs check processing CT1. When line concentration relay unit 42 checks that DHCPv6 packet 402 does not include the VS option including identification code Cd, line concentration relay unit 42 recognizes that DHCPv6 packet 402 is a packet to which the transfer information, i.e., “RF” indicating the message type in message header 451mh has not been added in subscriber line management unit 32.

Then, line concentration relay unit 42, for example, adds the transfer information to DHCPv6 packet 402 and transmits the packet to server 151.

Specifically, line concentration relay unit 42, for example, creates a message 453msg including payload 402p of DHCPv6 packet 402, the transfer information and the output source information, and creates an RF packet 453 which is a packet in which created message 453msg is stored in a payload 453p.

More specifically, line concentration relay unit 42, for example, creates RF packet 453 using the method for creating RF packet 451 shown in FIG. 7 and the method for creating RF packet 452 shown in FIG. 9.

Based on the contents of IPv6 header 402h and UDP header 402u of DHCPv6 packet 402, line concentration relay unit 42, for example, creates IPv6 header 452h and UDP header 451u shown in FIG. 9, respectively.

In addition, line concentration relay unit 42, for example, creates RM option 451rmo shown in FIG. 7 as well as message header 452mh, VS option 452vso and other options 452etc shown in FIG. 9.

Then, line concentration relay unit 42, for example, creates RF packet 453 shown in FIG. 10 by combining IPv6 header 452h, UDP header 451u, message header 452mh, RM option 451rmo, VS option 452vso, and other options 452etc in the listed order. The order of options opt in RF packet 453 may be changed.

Line concentration relay unit 42 outputs RF packet 453 thus created to server-side communication unit 43.

When server-side communication unit 43 receives RF packet 452 or RF packet 453 from line concentration relay unit 42, server-side communication unit 43, for example, transmits received RF packet 452 or RF packet 453 to server 151.

[Processing in Server 151]

Referring again to FIG. 1, when server 151 receives RF packet 452 or RF packet 453 from packet relay apparatus 101, server 151, for example, creates response packet 401 to received RF packet 452 or RF packet 453. Server 151 transmits created packet 401 to packet relay apparatus 101.

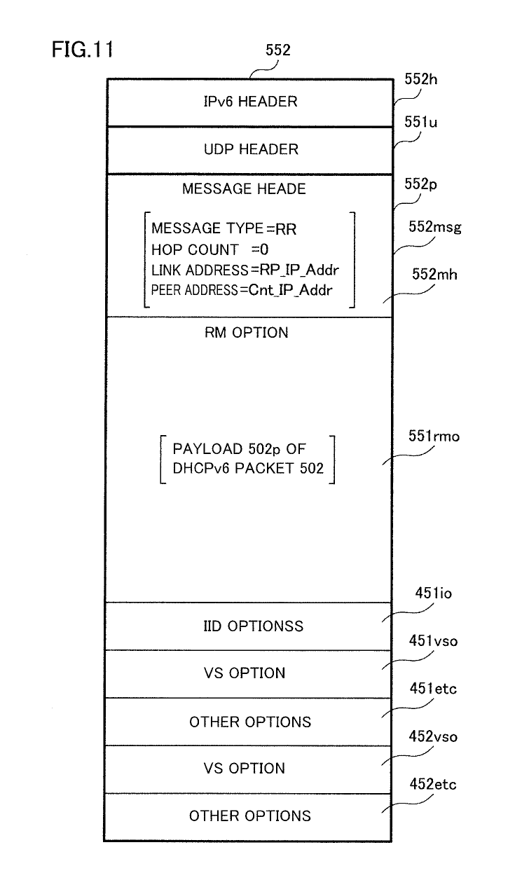

FIG. 11 is a diagram showing one example of an RR packet created in the server according to the embodiment of the present invention.

Referring to FIG. 11, server 151, for example, creates response packet 401 to packet 401 transmitted by packet relay apparatus 101, specifically RF packet 451 or RF packet 452. Response packet 401 is a packet including response information indicating a response to the transfer information, and the output source information. Specifically, when server 151 receives RF packet 452 shown in FIG. 9 from packet relay apparatus 101, server 151, for example, creates an RR packet 552 which is response packet 401 to received RF packet 452.

More specifically, server 151, for example, performs packet decomposition processing for obtaining RM option 451rmo, IID option 451io, VS option 451vso, other options 451etc, VS option 452vso, and other options 452etc as well as message header 452mh from message 452msg included in received RF packet 452.

Now, IID option 451io, VS option 451vso, other options 451etc, VS option 452vso, and other options 452etc are stored in RR packet 552 without any change.

Server 151, for example, obtains the ONU index from variable region optv of IID option 451io. Server 151 uses the obtained ONU index to determine subscriber terminal apparatus 121.

Specifically, server 151 uses the ONU index to limit the number of the IPv6 addresses passed to identical subscriber terminal apparatus 121.

In addition, server 151, for example, creates a provisional message header obtained by copying message header 452mh, and creates a message header 552mh obtained by rewriting the message type in the created provisional message header into “RR”.

This “RR” which is the message type included in message header 552mh corresponds to the response information, for example. The message type “RR” means, for example, that a message 552msg is a relay reply message.

In addition, server 151, for example, obtains payload 402p of DHCPv6 packet 402 from variable region optv of RM option 451rmo. Server 151 creates reply information which is a response to the request information included in obtained payload 402p.

Then, server 151 creates an RM option 551rmo in which the created reply information is stored in variable region optv. The reply information stored in variable region optv is the information which is stored in a payload 502p of a DHCPv6 packet 502 shown in FIG. 4 and is scheduled to be transmitted from packet relay apparatus 101 to client 111.

In addition, server 151, for example, creates an IPv6 header 552h and a UDP header 551u obtained by copying IPv6 header 452h and UDP header 451u, respectively. At this time, server 151, for example, rewrites the address information included in IPv6 header 552h, when needed. In addition, server 151 writes a prescribed port number, e.g., 546 indicating that RR packet 552 is a packet used for the DHCP processing, to UDP header 551u.

Server 151, for example, creates RR packet 552 by combining IPv6 header 552h, UDP header 551u, message header 552mh, RM option 551rmo, IID option 451io, VS option 451vso, other options 451etc, VS option 452vso, and other options 452etc in the listed order. The order of options opt in RR packet 552 may be changed.

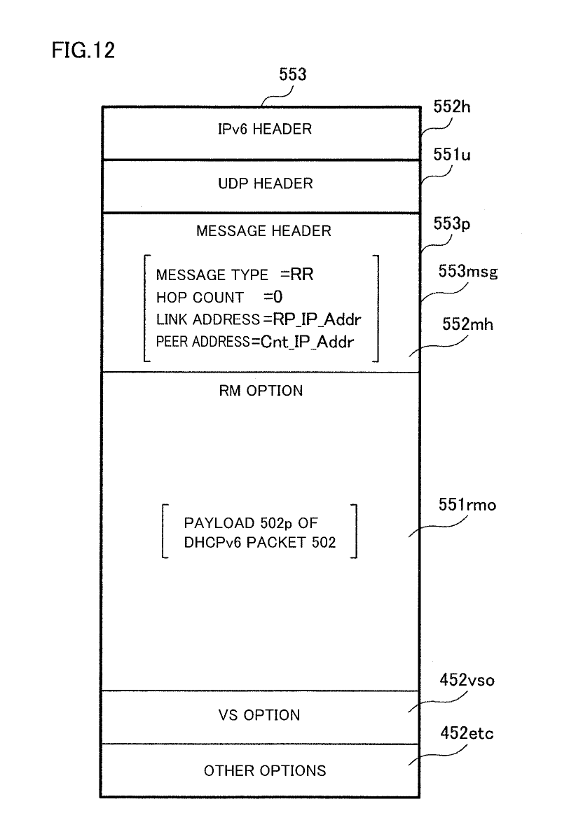

FIG. 12 is a diagram showing one example of an RR packet created in the server according to the embodiment of the present invention.

Referring to FIG. 12, when server 151 receives RF packet 453 shown in FIG. 10 from packet relay apparatus 101, server 151, for example, creates an RR packet 553 which is response packet 401 to received RF packet 453.

More specifically, using a method similar to the method for creating RR packet 552 shown in FIG. 11, server 151, for example, performs the processing for creating IPv6 header 552h, UDP header 551u, message header 552mh, and RM option 551rmo and the processing for obtaining VS option 452vso and other options 452etc.

Then, server 151, for example, creates RR packet 553 by combining IPv6 header 552h, UDP header 551u, message header 552mh, RM option 551rmo, VS option 452vso, and other options 452etc in the listed order. The order of options opt in RR packet 553 may be changed.

Referring again to FIG. 1, server 151, for example, transmits created response packet 401 to packet relay apparatus 101.

When packet relay apparatus 101 receives response packet 401 from server 151, packet relay apparatus 101, for example, relays received response packet 401 to client 111 via subscriber terminal apparatus 121.

Referring again to FIG. 8, when server-side communication unit 43 in relay processing unit 22 receives RR packet 552 or RR packet 553 from server 151 as response packet 401, server-side communication unit 43, for example, outputs received RR packet 552 or RR packet 553 to line concentration relay unit 42.

[RR Packet 552 Including Addition Information]

When response packet 401 received by server-side communication unit 43 has the addition information, line concentration relay unit 42, for example, outputs response packet 401 to subscriber line management unit 32 in management processing unit 21 without deleting the response information.

Specifically, when line concentration relay unit 42 receives RR packet 552 shown in FIG. 11 from server-side communication unit 43 as response packet 401, line concentration relay unit 42, for example, performs check processing CT2 for checking whether or not received RR packet 552 includes the VS option including identification code Cd.

When line concentration relay unit 42 checks in check processing CT2 that RR packet 552 includes VS option 451vso including identification code Cd, line concentration relay unit 42, for example, recognizes that RR packet 552 is a response packet to RF packet 45 to which the transfer information has been added in subscriber line management unit 32.

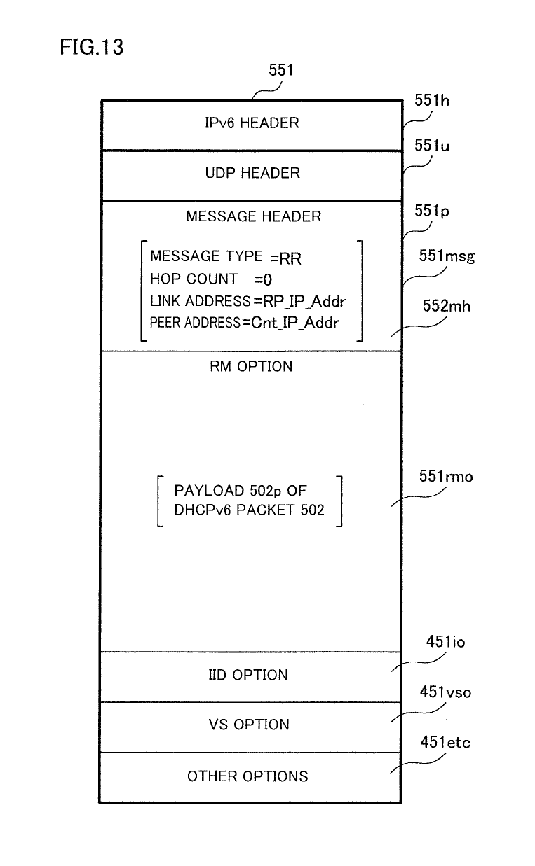

FIG. 13 is a diagram showing one example of an RR packet obtained by deleting the options in the line concentration relay unit according to the embodiment of the present invention.

Referring to FIG. 13, line concentration relay unit 42, for example, obtains the output source information from response packet 401 received by server-side communication unit 43. Line concentration relay unit 42 outputs response packet 401 from which the output source information has been deleted to subscriber line management unit 32 indicated by the obtained output source information.

Specifically, line concentration relay unit 42, for example, obtains Pnum which is the communication port number, from variable region optv of VS option 452vso in RR packet 552.

Then, line concentration relay unit 42, for example, creates an RR packet 551 based on RR packet 552. More specifically, line concentration relay unit 42, for example, rewrites the address information included in IPv6 header 552h in RR packet 552 when needed, and creates an IPv6 header 551h.

In addition, line concentration relay unit 42, for example, creates a message 551msg based on message 552msg. Specifically, line concentration relay unit 42, for example, creates message 551msg obtained by deleting VS option 452vso and other options 452etc from message 552msg.

Line concentration relay unit 42, for example, outputs created RR packet 551 to communication port 41 indicated by Pnum.

When communication port 41 indicated by Pnum receives RR packet 551 from line concentration relay unit 42, communication port 41, for example, outputs received RR packet 551 to management processing unit 21 connected to communication port 41 in one-to-one relation.

Referring again to FIG. 6, when DHCPv6 packet obtainment unit 33 receives RR packet 551 from communication port 41 in relay processing unit 22, DHCPv6 packet obtainment unit 33, for example, obtains the port number included in UDP header 551u of received RR packet 551.

When DHCPv6 packet obtainment unit 33 checks that the obtained port number is 546, DHCPv6 packet obtainment unit 33, for example, recognizes that RR packet 551 is a packet used for the DHCP processing. In this case, DHCPv6 packet obtainment unit 33 outputs RR packet 551 to subscriber line management unit 32.

In addition, when the port number of packet 401 received from communication port 41 in relay processing unit 22 is a number other than 546, DHCPv6 packet obtainment unit 33, for example, recognizes that packet 401 is a normal packet to be relayed. In this case, DHCPv6 packet obtainment unit 33 transmits packet 401 to subscriber terminal apparatus 121 via client-side communication unit 31.

When subscriber line management unit 32 receives RR packet 551 from DHCPv6 packet obtainment unit 33, subscriber line management unit 32, for example, performs check processing CT3 for checking whether or not received RR packet 551 includes the VS option including identification code Cd.

When subscriber line management unit 32 checks in check processing CT3 that RR packet 551 includes VS option 451vso including identification code Cd, subscriber line management unit 32, for example, recognizes that RR packet 551 is a response packet to RF packet 451 to which subscriber line management unit 32 has added the transfer information.

Then, subscriber line management unit 32, for example, creates DHCPv6 packet 502 shown in FIG. 4 based on RR packet 551. More specifically, line concentration relay unit 42 creates DHCPv6 packet 502 in which the information of variable region optv in RM option 551rmo of RR packet 551 is included in payload 502p.

Subscriber line management unit 32 incorporates the peer address in message header 552mh into IPv6 header 502h as a destination address. In addition, subscriber line management unit 32, for example, creates a UDP header 502u by copying UDP header 551u. Then, subscriber line management unit 32 transmits created DHCPv6 packet 502 to destination client 111 via client-side communication unit 31 and subscriber terminal apparatus 121.

[RR Packet 553 not Including Addition Information]

Referring again to FIG. 8, when response packet 401 received by server-side communication unit 43 does not have the addition information, line concentration relay unit 42, for example, outputs response packet 401 from which the response information has been deleted to subscriber line management unit 32.

Specifically, when line concentration relay unit 42 receives RR packet 553 shown in FIG. 12 from server-side communication unit 43 as response packet 401, line concentration relay unit 42, for example, performs check processing CT2 for checking whether or not received RR packet 553 includes the VS option including identification code Cd.

When line concentration relay unit 42 checks in check processing CT2 that RR packet 553 does not include VS option 451vso including identification code Cd, line concentration relay unit 42, for example, recognizes that RR packet 553 is a response packet to DHCPv6 packet 402 to which the transfer information has not been added in subscriber line management unit 32.

Line concentration relay unit 42, for example, obtains Pnum which is the communication port number, from variable region optv of VS option 452vso in RR packet 553.

Then, line concentration relay unit 42, for example, creates DHCPv6 packet 502 shown in FIG. 4 based on RR packet 553. More specifically, line concentration relay unit 42, for example, creates DHCPv6 packet 502 in which the information of variable region optv in RM option 551rmo of RR packet 553 is stored in payload 502p.

Line concentration relay unit 42 incorporates the peer address in message header 552mh into IPv6 header 502h as a destination address. In addition, line concentration relay unit 42, for example, creates UDP header 502u by copying UDP header 551u. Line concentration relay unit 42, for example, outputs created DHCPv6 packet 502 to management processing unit 21 via communication port 41 indicated by Pnum.

Referring again to FIG. 6, when DHCPv6 packet obtainment unit 33 receives DHCPv6 packet 502 from communication port 41 in relay processing unit 22, DHCPv6 packet obtainment unit 33, for example, recognizes that DHCPv6 packet 502 is a packet used for the DHCP processing, based on the port number. DHCPv6 packet obtainment unit 33 outputs DHCPv6 packet 502 to subscriber line management unit 32.

When subscriber line management unit 32 receives DHCPv6 packet 502 from DHCPv6 packet obtainment unit 33, subscriber line management unit 32, for example, performs check processing CT3 for checking whether or not received DHCPv6 packet 502 includes the VS option including identification code Cd.

When subscriber line management unit 32 checks in check processing CT3 that DHCPv6 packet 502 does not include the VS option including identification code Cd, subscriber line management unit 32, for example, transmits DHCPv6 packet 502 to destination client 111 via client-side communication unit 31 and subscriber terminal apparatus 121 without any change.

[Operation]

Packet relay apparatus 101 includes a computer, and a computation processing unit such as a CPU in the computer reads out a program including a part or all of the steps in the following flowcharts from a not-shown memory and executes the program. This program of the apparatus can be installed from outside. This program of the apparatus is stored in a recording medium and distributed.

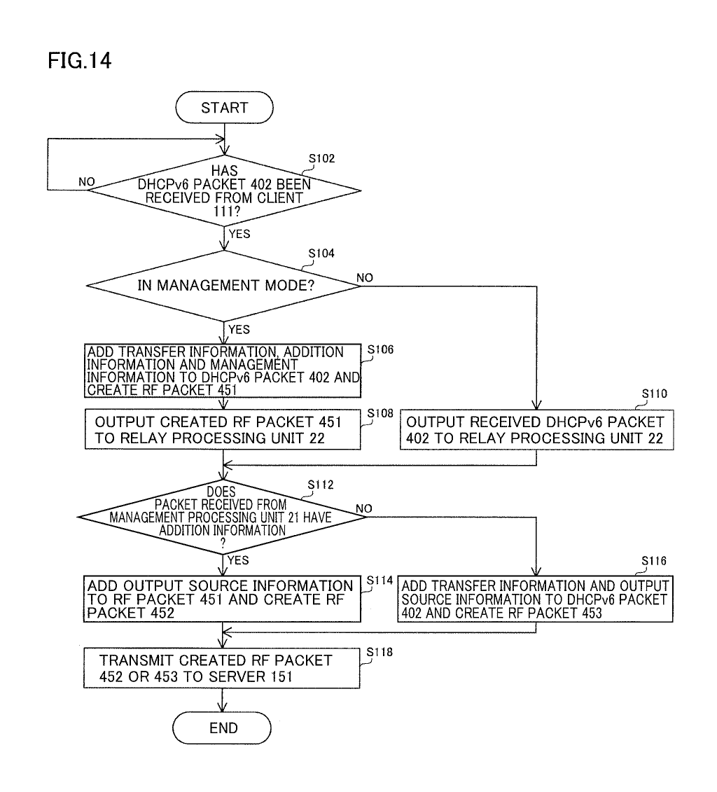

FIG. 14 is a flowchart defining an operation procedure when the packet relay apparatus according to the embodiment of the present invention performs the processing for relaying the DHCPv6 packet in an uplink direction.

Referring to FIG. 14, management processing unit 21 in packet relay apparatus 101 first awaits until management processing unit 21 receives DHCPv6 packet 402 from client 111 via subscriber terminal apparatus 121 (NO in step S102).

Next, if management processing unit 21 receives DHCPv6 packet 402 from client 111 when the operation mode of management processing unit 21 is in the non-management mode (YES in step S102 and NO in step S104), management processing unit 21 outputs received DHCPv6 packet 402 to relay processing unit 22 (step S110).

On the other hand, if management processing unit 21 receives DHCPv6 packet 402 from client 111 when the operation mode of management processing unit 21 is in the management mode (YES in step S102 and YES in step S104), management processing unit 21 adds the transfer information, the addition information and the management information to received DHCPv6 packet 402 and creates RF packet 451 (step S106).

Specifically, management processing unit 21 adds message header 451mh, VS option 451vso and IID option 451io that include the transfer information, the addition information and the management information, respectively, as well as other options 451etc, and option header opth in RM option 451rmo, to received DHCPv6 packet 402, and creates RF packet 451.

Next, management processing unit 21 outputs created RF packet 451 to relay processing unit 22 (step S108).

Next, if the packet received from management processing unit 21 does not have the addition information (NO in step S112), relay processing unit 22 adds the transfer information and the output source information to the received packet and creates RF packet 453 (step S116).

Specifically, when the packet received from management processing unit 21 is DHCPv6 packet 402, relay processing unit 22 adds message header 452mh and VS option 452vso that include the transfer information and the output source information, respectively, as well as other options 452etc, and option header opth in RM option 451rmo, to received DHCPv6 packet 402, and creates RF packet 453.

On the other hand, if the packet received from management processing unit 21 has the addition information (YES in step S112), relay processing unit 22 adds the output source information to the received packet and creates RF packet 452 (step S114).

Specifically, when the packet received from management processing unit 21 is RF packet 451, relay processing unit 22 adds VS option 452vso including the output source information, as well as other options 452etc to received RF packet 451, and creates RF packet 452.

Next, relay processing unit 22 transmits created RF packet 453 or RF packet 452 to server 151 (step S118).

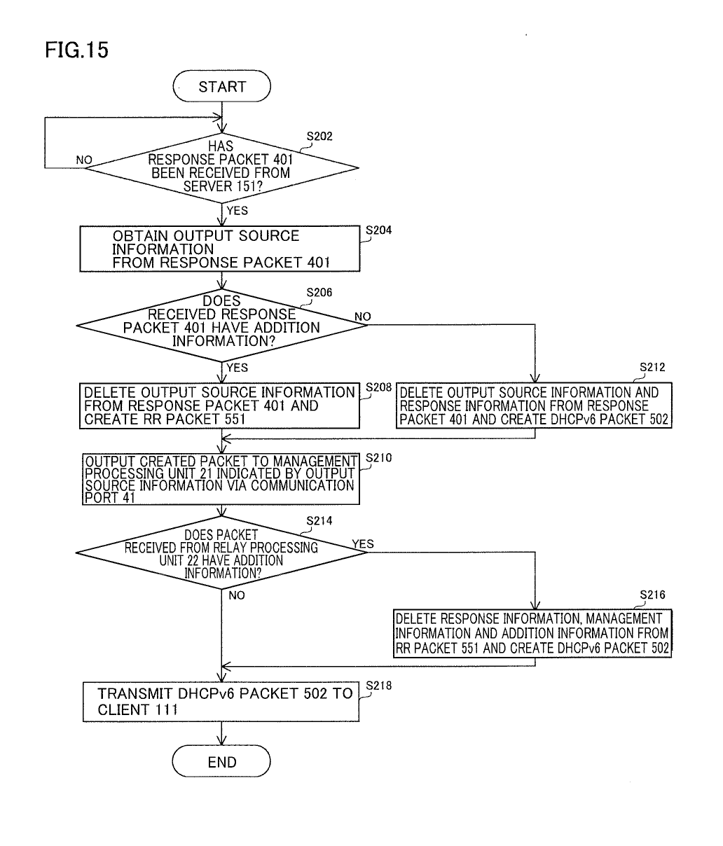

FIG. 15 is a flowchart defining an operation procedure when the packet relay apparatus according to the embodiment of the present invention performs the processing for relaying the DHCPv6 packet in a downlink direction.

Referring to FIG. 15, relay processing unit 22 in packet relay apparatus 101 first awaits until relay processing unit 22 receives response packet 401 from server 151 (NO in step S202).

Next, if relay processing unit 22 receives response packet 401 from server 151 (YES in step S202), relay processing unit 22 obtains the output source information from VS option 452vso in response packet 401 (step S204).

Next, if response packet 401 has the addition information (YES in step S206), relay processing unit 22 deletes the output source information from response packet 401 and creates RR packet 551 (step S208).

Specifically, when response packet 401 is RR packet 552, relay processing unit 22 deletes VS option 452vso including the output source information as well as other options 452etc from RR packet 552 and creates RR packet 551.

On the other hand, if response packet 401 does not have the addition information (NO in step S206), relay processing unit 22 deletes the output source information and the response information from response packet 401 and creates DHCPv6 packet 502 (step S212).

Specifically, when response packet 401 is RR packet 553, relay processing unit 22 deletes VS option 452vso and message header 552mh that include the output source information and the response information, respectively, as well as other options 452etc, and option header opth in RM option 551rmo from RR packet 553, and creates DHCPv6 packet 502.

Next, relay processing unit 22 outputs created RR packet 551 or DHCPv6 packet 502 to management processing unit 21 indicated by the output source information (step S210).

Next, if the packet received from relay processing unit 22 does not have the addition information (NO in step S214), management processing unit 21 transmits the packet, specifically DHCPv6 packet 502, to client 111 via subscriber terminal apparatus 121 (step S218).

On the other hand, if the packet received from relay processing unit 22 has the addition information (YES in step S214), management processing unit 21 deletes the response information, the management information and the addition information from the packet received from relay processing unit 22, and creates DHCPv6 packet 502 (step S216).

Specifically, when the packet received from relay processing unit 22 is RR packet 551, management processing unit 21 deletes message header 552mh, IID option 451io and VS option 451vso that include the response information, the management information and the addition information, respectively, as well as other options 451etc, and option header opth in RM option 551rmo from RR packet 551, and creates DHCPv6 packet 502.

Next, management processing unit 21 transmits created DHCPv6 packet 502 to client 111 via subscriber terminal apparatus 121 (step S218).

For example, when the packet relay apparatus transfers the packet received from the client, the packet relay apparatus adds the transfer information indicating that the packet relay apparatus has transferred the packet to the packet in accordance with RFC6221.

For example, when the packet relay apparatus relays the packet having the above-described transfer information added thereto to a different network, the packet relay apparatus adds the transfer information indicating that the packet relay apparatus has transferred the packet to the packet in accordance with RFC3315, and transmits the packet to the DHCPv6 server via the network.

However, the two types of transfer information are added to the packet received from the packet relay apparatus by the DHCPv6 server. Therefore, the following problem may arise.

Specifically, when the two types of transfer information are added to the packet, the structure of the packet becomes complicated, for example. Therefore, the processing for analyzing the packet in the DHCPv6 server becomes complicated. The above-described problem will be specifically described below.

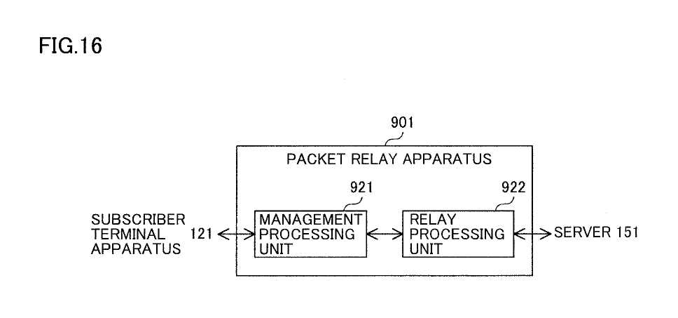

FIG. 16 is a diagram showing a configuration of a packet relay apparatus in a comparative example.

Referring to FIG. 16, a packet relay apparatus 901 in the comparative example includes a management processing unit 921 and a relay processing unit 922.

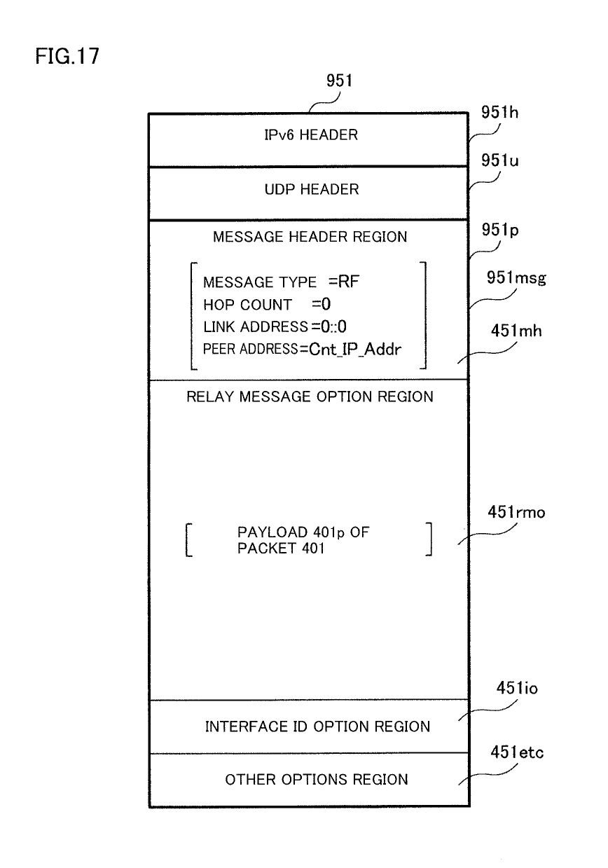

FIG. 17 is a diagram showing one example of a DHCPv6 packet encapsulated in the management processing unit of the packet relay apparatus in the comparative example.

Referring to FIG. 17, when management processing unit 921 receives DHCPv6 packet 402 from subscriber terminal apparatus 121, management processing unit 921, for example, creates an RF packet 951 obtained by encapsulating received DHCPv6 packet 402, and outputs RF packet 951 to relay processing unit 922.

A message 951msg is included in a payload 951p of RF packet 951. Message header 451mh, RM option 451rmo, IID option 451io, and other options 451etc are included in message 951msg.

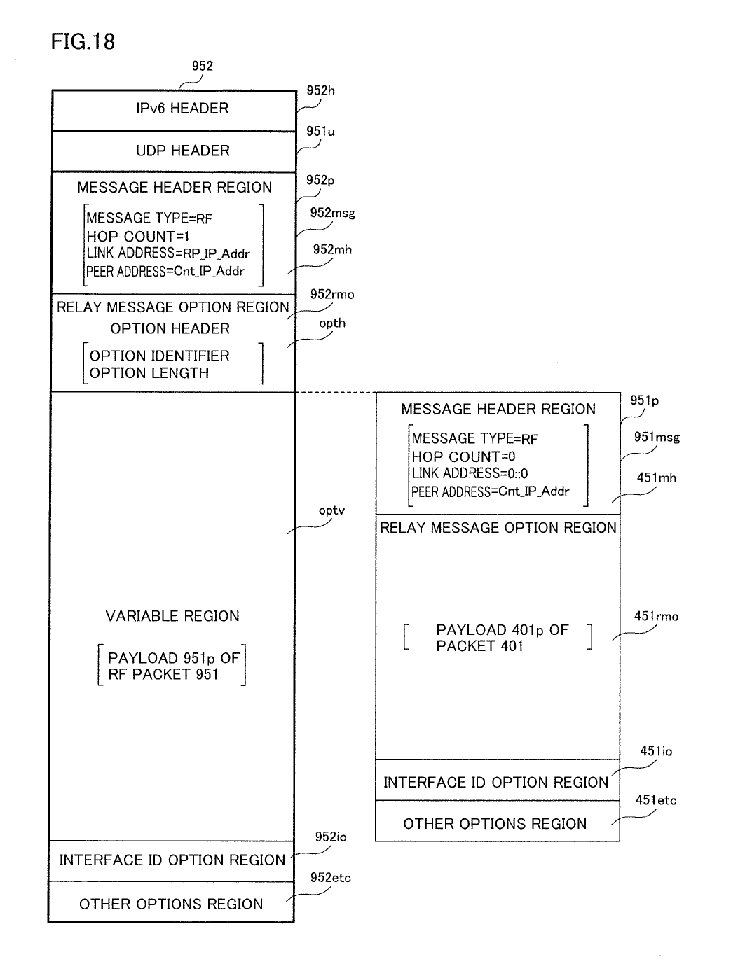

FIG. 18 is a diagram showing one example of an RF packet encapsulated in the relay processing unit of the packet relay apparatus in the comparative example.

Referring to FIG. 18, when relay processing unit 922 receives RF packet 951 from management processing unit 921, relay processing unit 922, for example, creates an RF packet 952 obtained by encapsulating received RF packet 951, and transmits RF packet 952 to server 151.

A message 952msg is included in a payload 952p of RF packet 952. A message header 952mh, an RM option 952rmo, an IID option 952io, and other options 952etc are included in message 952msg. In addition, a hop count in message header 952mh is 1 obtained by incrementing the hop count in message header 451mh.

Payload 951p, i.e., message 951msg, of RF packet 951 is included in variable region optv of RM option 952rmo.

When server 151 receives RF packet 952 from packet relay apparatus 901, server 151, for example, performs the packet decomposition processing for obtaining RM option 952rmo, IID option 952io and other options 952etc as well as message header 952mh from message 952msg included in received RF packet 952.

Since the value of the hop count included in message header 952mh is 1, server 151, for example, recognizes that RF packet 952 is a packet transferred twice.

Then, server 151, for example, obtains message 951msg included in variable region optv of RM option 952rmo, based on an option length included in option header opth of RM option 952rmo.

Server 151, for example, performs the packet decomposition processing for obtaining RM option 451rmo, IID option 451io and other options 451etc as well as message header 451mh from obtained message 951msg.

Then, server 151, for example, obtains an ONU index from variable region optv of IID option 451io, and uses the obtained ONU index to determine subscriber terminal apparatus 121.

As described above, the structure of RF packet 952 having the two types of transfer information added thereto is complicated, and thus, the processing for analyzing RF packet 952 in server 151 is complicated.

In contrast, in the packet relay apparatus according to the embodiment of the present invention, client-side communication unit 31 receives DHCPv6 packet 402. Subscriber line management unit 32 adds message header 451mh including the transfer information to DHCPv6 packet 402 received by client-side communication unit 31, and outputs DHCPv6 packet 402. The transfer information indicates that DHCPv6 packet 402 is a packet transferred by packet relay apparatus 101. Line concentration relay unit 42 transmits the packet to the apparatus to which the packet is to be relayed, specifically server 151, without adding the transfer information, when the packet received from subscriber line management unit 32 has the transfer information.

As described above, in the embodiment of the present invention, the packet is transmitted to server 151, without adding a plurality of types of transfer information to one packet. Since the packet having a simple structure can be transmitted to server 151, the processing for analyzing the packet in server 151 can be simplified. Therefore, it is possible to reduce the load of processing the packet in the apparatus to which the packet is to be relayed.

In addition, transfer of the packet having the value of the hop count equal to or larger than a prescribed value may, for example, be limited in communication system 301.

Packet relay apparatus 901 in the comparative example transmits, to server 151, RF packet 952 in which the value of the hop count included in message header 952mh is 1. On the other hand, as for the packet transmitted from packet relay apparatus 101, the value of the hop count included in message header 452mh is zero, and thus, the remaining number of times of possible transfer is larger than that of the packet transmitted from packet relay apparatus 901. Therefore, the possibility of arrival of the transmitted packet at the target apparatus can be further increased.

In addition, when packet relay apparatus 901 adds the management information used in server 151 to DHCPv6 packet 402 received from client 111, packet relay apparatus 901, for example, adds the transfer information indicating that packet relay apparatus 901 has transferred the packet to the packet in accordance with RFC6221.

In addition, when packet relay apparatus 901 relays the packet having the management information and the transfer information added thereto to a different network, packet relay apparatus 901, for example, adds the transfer information indicating that packet relay apparatus 901 has transferred the packet to the packet in accordance with RFC3315, and transmits the packet to server 151 via the network.

However, the two types of transfer information are added to the packet received from packet relay apparatus 901 by the DHCPv6 server. Therefore, the following problem may arise.

Specifically, when the two types of transfer information are added to the packet, the structure of the packet becomes complicated, for example. Therefore, the load of processing for server 151 to obtain the management information added when the first transfer in accordance with RFC6221 is performed in packet relay apparatus 901 becomes great.

For example, when server 151 cannot analyze the packet subjected to transfer two or more times, server 151 cannot correctly obtain the management information added when the first transfer in accordance with RFC6221 is performed in packet relay apparatus 901.

In addition, server 151 may recognize that the information, i.e., the ONU index added when the first transfer is performed in packet relay apparatus 901 is located in, for example, a one-step lower network layer. In such a case, server 151 cannot correctly obtain the ONU index in some cases.

In contrast, in the packet relay apparatus according to the embodiment of the present invention, subscriber line management unit 32 further adds IID option 451io including the management information to DHCPv6 packet 402 and outputs DHCPv6 packet 402. The management information is the information about the apparatus having transmitted DHCPv6 packet 402, specifically subscriber terminal apparatus 121, and is the information used to determine subscriber terminal apparatus 121 in server 151.

With this configuration, server 151 can correctly obtain the management information or obtain the management information by the simple processing. Therefore, subscriber terminal apparatus 121 can be appropriately determined using the management information.

In addition, in the packet relay apparatus according to the embodiment of the present invention, line concentration relay unit 42 adds the output source information to the packet received from subscriber line management unit 32 and transmits the packet to server 151. The output source information indicates subscriber line management unit 32 having output the packet.

With this configuration, even if packet relay apparatus 101 includes a plurality of subscriber line management units 32, for example, line concentration relay unit 42 can correctly determine subscriber line management unit 32 to which the response packet to the packet transmitted to server 151 is to be output, based on the output source information included in the response packet, when line concentration relay unit 42 receives the response packet from server 151.

In addition, in the packet relay apparatus according to the embodiment of the present invention, server-side communication unit 43 receives the response packet from server 151. The response packet is a response packet to the packet transmitted by packet relay apparatus 101 and is a packet including the output source information. Then, line concentration relay unit 42 obtains the output source information from the response packet received by server-side communication unit 43, and outputs the response packet from which the output source information has been deleted to subscriber line management unit 32 indicated by the output source information.

With this configuration in which the response packet from which the output source information has been deleted is output, the type of the packet corresponding to the type of the packet output by subscriber line management unit 32 can be output to subscriber line management unit 32. Therefore, the processing in subscriber line management unit 32 can be simplified.

In addition, in the packet relay apparatus according to the embodiment of the present invention, subscriber line management unit 32 can set whether or not to add the transfer information. Line concentration relay unit 42 adds message header 452mh including the transfer information to the packet and transmits the packet to server 151, when the packet received from subscriber line management unit 32 does not have the transfer information.

With this configuration, subscriber line management unit 32 can select whether or not to add the transfer information to the packet. Even if subscriber line management unit 32 does not add the transfer information to the packet, line concentration relay unit 42 adds the transfer information to the packet, and thus, server 151 can correctly process the packet received from packet relay apparatus 101.

In addition, in the packet relay apparatus according to the embodiment of the present invention, subscriber line management unit 32 further adds VS option 451vso including the addition information to DHCPv6 packet 402. The addition information indicates that subscriber line management unit 32 has added the transfer information to DHCPv6 packet 402 received by client-side communication unit 31. Line concentration relay unit 42 adds message header 452mh including the transfer information to the packet and transmits the packet to server 151, when the packet received from subscriber line management unit 32 does not have VS option 45 lvso.

With this configuration, line concentration relay unit 42 can correctly determine whether or not subscriber line management unit 32 has added the transfer information, based on the content of VS option 451vso. Therefore, addition of a plurality of types of transfer information to one packet can be more reliably prevented by the simple processing.

In addition, in the packet relay apparatus according to the embodiment of the present invention, server-side communication unit 43 receives response packet 401 from server 151. Response packet 401 is a response packet to the packet transmitted by packet relay apparatus 101, and is a packet including the response information indicating the response to the transfer information. Line concentration relay unit 42 outputs response packet 401 from which the response information has been deleted to subscriber line management unit 32, when response packet 401 received by server-side communication unit 43 does not have VS option 451vso including the addition information.

As described above, the packet relay apparatus is configured such that response packet 401 from which the response information has been deleted is output to subscriber line management unit 32 that has output the packet not having the transfer information added thereto, i.e., DHCPv6 packet 402 to line concentration relay unit 42. The type of the packet corresponding to the type of the packet output by subscriber line management unit 32 can be output to subscriber line management unit 32. Therefore, the processing in subscriber line management unit 32 can be simplified.

In addition, in the packet relay apparatus according to the embodiment of the present invention, subscriber line management unit 32 and line concentration relay unit 42 operate in accordance with RFC6221 and RFC3315, respectively.

With this configuration, subscriber line management unit 32 and line concentration relay unit 42 satisfy the specifications of RFC6221 and RFC3315, respectively. Therefore, DHCPv6 packet 402 and DHCPv6 packet 502 received and transmitted between server 151 and client 111 that satisfy these specifications can be appropriately relayed.

It should be understood that the above-described embodiment is illustrative and not limitative in any respect. The scope of the present invention is defined by the terms of the claims, rather than the description above, and is intended to include any modifications within the scope and meaning equivalent to the terms of the claims. The description above includes the feature indicated in the following appended notes:

[Appended Note 1]

A packet relay apparatus comprising:

a reception unit configured to receive a packet;

a management unit configured to add transfer information to the packet received by the reception unit and output the packet, the transfer information indicating that the packet is a packet transferred by the packet relay apparatus; and

a relay unit configured to transmit the packet to an apparatus to which the packet is to be relayed, without adding the transfer information, when the packet received from the management unit has the transfer information,

the reception unit being configured to receive the packet from a DHCPv6 client,

the management unit being configured to create a relay forward option including a payload of the packet received by the reception unit and a message header including the transfer information, and create and output the packet in which the created relay forward option and message header are stored in the payload,

the relay unit being configured to add information indicating that the relay unit has performed the processing for relaying the packet to the message header, without adding the transfer information, and transmit the packet to a DHCPv6 server which is the apparatus to which the packet is to be relayed, when the packet received from the management unit has the transfer information,

the DHCPv6 client and the management unit belonging to an identical network,

the DHCPv6 client and the DHCPv6 server belonging to different networks.

### REFERENCE SIGNS LIST

21 management processing unit; 22 relay processing unit; 23 setting unit; 31 client-side communication (reception unit); 32 subscriber line management unit; 33 DHCPv6 packet obtainment unit; 41 communication port; 42 line concentration relay unit; 43 server-side communication unit (reception unit); 101 packet relay apparatus; 111 DHCPv6 client; 121 subscriber terminal apparatus; 151 DHCPv6 server; 301 communication system.

1. A packet relay apparatus comprising:
a reception unit configured to receive a packet;
a management unit configured to add transfer information to the packet received by the reception unit and output the packet, the transfer information indicating that the packet is a packet transferred by the packet relay apparatus; and
a relay unit configured to transmit the packet to an apparatus to which the packet is to be relayed, without adding the transfer information, when the packet received from the management unit has the transfer information.

2. The packet relay apparatus according to claim 1, wherein
the management unit is configured to further add management information to the packet and output the packet, the management information being the information about an apparatus having transmitted the packet and being the information used to determine the apparatus having transmitted the packet in the apparatus to which the packet is to be relayed.

3. The packet relay apparatus according to claim 1, wherein
the relay unit is configured to add output source information to the packet received from the management unit, and transmit the packet to the apparatus to which the packet is to be relayed, the output source information indicating the management unit having output the packet.

4. The packet relay apparatus according to claim 3, wherein
the reception unit is configured to further receive a response packet from the apparatus to which the packet is to be relayed, the response packet being a response packet to the packet transmitted by the packet relay apparatus and being a packet including the output source information, and
the relay unit is configured to obtain the output source information from the response packet received by the reception unit, and output the response packet from which the output source information has been deleted to the management unit indicated by the output source information.

5. The packet relay apparatus according to claim 1, wherein
the management unit is configured to be able to set whether or not to add the transfer information, and
the relay unit is configured to add the transfer information to the packet and transmit the packet to the apparatus to which the packet is to be relayed, when the packet received from the management unit does not have the transfer information.

6. The packet relay apparatus according to claim 5, wherein
the management unit is configured to further add addition information to the packet, the addition information indicating that the management unit has added the transfer information to the packet received by the reception unit, and
the relay unit is configured to add the transfer information to the packet and transmit the packet to the apparatus to which the packet is to be relayed, when the packet received from the management unit does not have the addition information.

7. The packet relay apparatus according to claim 6, wherein
the reception unit is configured to further receive a response packet from the apparatus to which the packet is to be relayed, the response packet being a response packet to the packet transmitted by the packet relay apparatus and being a packet including response information indicating a response to the transfer information, and
the relay unit is configured to output the response packet from which the response information has been deleted to the management unit, when the response packet received by the reception unit does not have the addition information.

8. The packet relay apparatus according to claim 1, wherein
the management unit and the relay unit are configured to operate in accordance with RFC6221 and RFC3315, respectively.

9. A packet relay method in a packet relay apparatus, the packet relay method comprising:
receiving a packet;
adding transfer information to the received packet and outputting the received packet in accordance with a first protocol, the transfer information indicating that the received packet is a packet transferred by the packet relay apparatus; and
transmitting the packet to an apparatus to which the packet is to be relayed, in accordance with a second protocol, without adding the transfer information, when the received packet has the transfer information.
